(19) United States
(12) Patent Application Publication
(10) Pub. No.: US 2008/0261704 A1
(43) Pub. Date: Oct. 23, 2008

(54) SHAFT TUBE SYSTEM FOR BRAKE FOUNDATION

(76) Inventor: Claude DROUIN, Quebec (CA)

Correspondence Address: OGILVY RENAULT LLP, 1981 MCGILL COLLEGE AVENUE, SUITE 1600, MONTREAL, QC, H3A2Y3, CA

(21) Appl. No.: 12/106,578

(22) Filed: Apr. 21, 2008

Related U.S. Application Data
(60) Provisional application No. 60/912,933, filed on Apr. 20, 2007.

(51) Int. Cl. F16N 1/00

(52) U.S. Cl. 464/7

(57) ABSTRACT

A shaft tube system comprises a shaft having an elongated body, a cam at a brake end and a coupler at an actuated end. A shaft tube accommodates the shaft such that a cavity is defined between the elongated body of the shaft and an interior of the shaft tube with the shaft being rotatable along its longitudinal axis within the shaft tube. The shaft tube has a blockable inlet in fluid communication with the cavity to supply lubricant to the cavity. Seals are positioned between the shaft and the shaft tube at opposed ends of the shaft tube so as to define a lubricant reserve in said cavity, to lubricate the shaft with respect to the interior of the shaft tube. A purge system has a purge outlet in the shaft tube in fluid communication with the cavity adjacent to the brake end for lubricant from the lubricant reserve to be purged therethrough, and a flow control member for each said purge outlet restricting an exit of lubricant through the purge outlet.

### CROSS-REFERENCE TO RELATED APPLICATION

This patent application claims priority on U.S. Provisional Patent Application No. 60/912,933, filed on Apr. 20, 2007.

### BACKGROUND OF THE APPLICATION

1. Field of the Application

The present disclosure relates to shaft tube systems or tube enclosure systems used in heavy-duty vehicle brake foundations and other applications in the automotive industry, and other industrial sectors like food processing or such applications where the lubricant must not contaminate a product or process, and more particularly to a lubricant purge system for such shaft tube systems or enclosures.

2. Background Art

Shaft tube systems, also referred to as tube enclosure systems or shaft tube enclosure systems, are used in the automotive industry and more particularly in heavy vehicles as an efficient solution for actuating brakes.

In camshaft/shaft tube/tube enclosure systems (hereinafter shaft tube systems), the shaft tube supports the cam shaft with two bearing journals and forms a lubricant reserve therewith to ensure the lubricated rotation of the shaft. The shaft tube features a seal which is positively installed at the brake end in the brake foundation to prevent the lubricant from escaping and contaminating the brake foundation. It also has a negative seal at the other end of the enclosure to allow purging of the lubricant when new lubricant needs to be introduced for periodic maintenance. These seals also prevent road contaminants from entering the lubricant reserve, as road contaminants would otherwise turn the lubricant into an abrasive compound that would contribute to the rapid wear of the shaft tube system. On the other hand, when it is required to change the lubricant in the lubricant reserve, the mere fact that the entry point to feed new lubricant is located between the bearing journals in conventional shaft tube systems, the positive seal at the application end of the tube causes a hydraulic lock of the lubricant on that particular side of the shaft tube system rendering new lubricant introduction impossible while the negative seal at the other end allows normal purge of the lubricant, resulting in at most a partial change of lubricant in the tube enclosure. A non-negligible amount of maintenance work is required due to the non-practical configuration of shaft tube systems. Often, it is required to remove the shaft from the shaft tube to perform a full purge of the lubricant in the lubricant reserve. In some cases, this represents so much work that shaft tube systems are left in place until they fail. Early failure of the said configuration is caused by lack of new lubrication at the application end bearing journals of the shaft and tube.

### SUMMARY

It is therefore an aim of the present disclosure to provide a novel camshaft/shaft tube system addressing issues associated with the prior art,

Therefore, in accordance with the present disclosure, there is provided a shaft tube system comprising: a shaft having an elongated body, a cam at a brake end and a coupler at an actuated end; a shaft tube accommodating the shaft such that a cavity is defined between the elongated body of the shaft and an interior of the shaft tube with the shaft being rotatable along its longitudinal axis within the shaft tube, the shaft tube having a blockable inlet in fluid communication with the cavity to supply lubricant to the cavity; seals positioned between the shaft and the shaft tube at opposed ends of the shaft tube so as to define a lubricant reserve in said cavity, to lubricate the shaft with respect to the interior of the shaft tube; and a purge system having at least one purge outlet in the shaft tube in fluid communication with the cavity adjacent to the brake end for lubricant from the lubricant reserve to be purged therethrough, and a flow control member for each said purge outlet restricting an exit of lubricant through the purge outlet.

### BRIEF DESCRIPTION OF THE DRAWINGS

FIG. 1 is a perspective view of a shaft tube system in accordance with an embodiment of the present invention;

FIG. 2 is a partly sectioned view of the shaft tube system of FIG. 1, with a cam shaft; and

FIG. 3 is an enlarged view of a portion of the shaft tube system of FIG. 2 illustrating a lubricant purge system.

### DESCRIPTION OF THE PREFERRED EMBODIMENTS

Referring now to the drawings and more particularly to FIG. 2, a shaft tube system is generally shown at 10. The shaft tube system is also referred to as camshaft tube system and tube enclosure system and the like in the automotive industry.

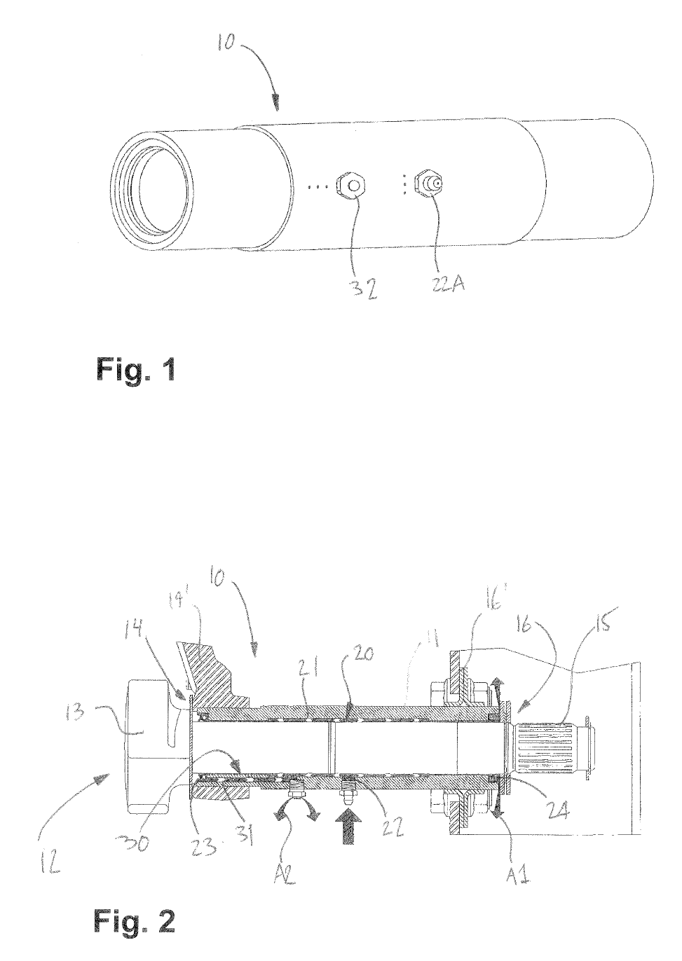

The shaft tube system 10 has, amongst other components, a shaft tube 11 and a cam shaft 12. The shaft tube 11 is generally shown in FIG. 1 without any cam shaft.

Referring to FIG. 2, the shaft tube system is generally shown at 10 with the shaft tube 11 being sectioned to illustrate an elongated body of the cam shaft 12 therein. The cam shaft 12 is accommodated in the shaft tube 11 so as to be rotatable along its longitudinal axis to actuate brakes or take part in other applications. The cam shaft 12 has a cam 13 (e.g., mixing screw, gear, spider cam, S cam or the like) extending out of the shaft tube 11 at a first end (i.e., the application end or brake end in a brake application), by which the cam 13 is connected to the brake in this specific heavy-vehicle brake configuration. The cam shaft 12 is rotatably supported at the brake end by bearing journal 14 (as part of the tube 11) The tube 11 is connected to the vehicle by a spider bracket 14′ or the like according to the intended application of the shaft tube system 10.

A coupler such as a spline 15 of the cam shaft 12 extends out of the shaft tube 11 at a second end (i.e., the actuated end). The cam shaft 12 is rotatably supported at the actuated end by spline journal 16 (as part of the tube 11). The spline 15 is connected to actuation means of the brake, and may be substituted for other equivalent types of couplers. The tube 11 is connected to the vehicle by a suspension beam 16′ (i.e., hanger bracket) or the like according to the intended application of the shaft tube system 10.

A lubricant reserve 20 is defined between the shaft tube 11 and the cam shaft 12 and sealing means described hereinafter. The lubricant reserve 20 has an annular cavity 21 filled with lubricant during operation of the brake, to lubricate the rotation of the shaft 12 with respect to the tube 11. An inlet featuring an inlet channel 22 of the lubricant reserve 20 is in fluid communication with the cavity 21 and is used to supply lubricant to the cavity 21. An injection port 22A (FIG. 1) is provided in the inlet to block the lubricant in the reserve 20 at a given pressure, and is adapted to be connected to a lubricant source to introduce and replace the lubricant in the reserve 20.

In order to maintain the lubricant in the lubricant reserve 20, seals are provided at opposed ends of the tube 11 (e.g., such as a cup seal). Application-end seal 23 is positioned between the shaft 12 and the tube 11 adjacent to the cam 13. The seal 23 is a cup seal positioned with its cup oriented toward the lubricant reserve 20 so as to be loaded by lubricant pressure in the lubricant reserve 20. Accordingly, the loaded seal 23 prevents the lubricant from escaping while keeping liquids and dirt from entering the lubricant reserve 20 from the brake end.

Actuated-end seal 24 is positioned between the shaft 12 and the tube 11 adjacent to the spline 15. The seal 24 is a cup seal positioned with its cup oriented away from the lubricant reserve 20. Accordingly, a pressure of lubricant beyond a given threshold in the lubricant reserve 20 will lead to the seal 24 deforming to allow lubricant to emerge out of the reserve 20, as illustrated by arrows A1. This operation is performed in a lubricant change, in the portion of the lubricant reserve 20 generally extending from the inlet channel 22 to the actuated end of the cam shaft 12.

In order to purge the lubricant in the portion of the lubricant reserve 20 extending from the inlet channel 22 to the application end of the cam shaft 12, without affecting the structural integrity of the brake-end seal 23, a lubricant purge system 30 is provided in the shaft tube 11.

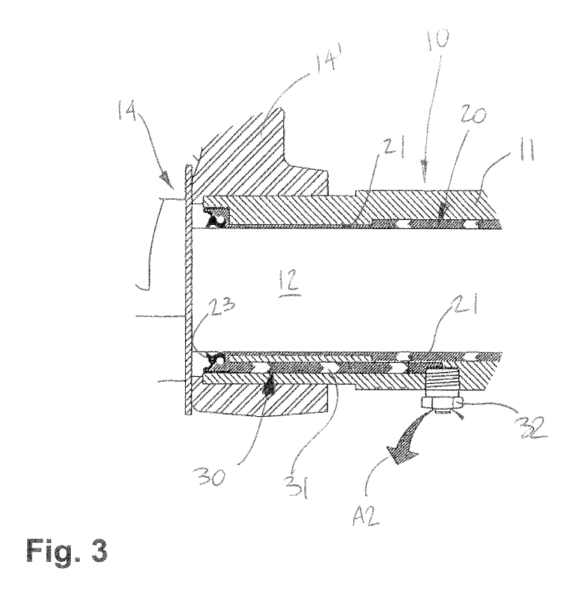

Referring concurrently to FIGS. 2 and 3, the lubricant purge system 30 has a purge outlet featuring a purge channel 31 extending longitudinally in the shaft tube 11. The purge channel. 31 is in fluid communication with the lubricant reserve 20 adjacent to the brake-end seal 23, and with a flow control member 32.

The flow control member 32 is typically a check valve that opens to allow lubricant to exit the reserve 20 therethrough as shown by arrows A2 when the lubricant pressure is beyond a predetermined pressure threshold. For instance, it is considered to use a needle-type check valve that opens at a lubricant pressure of 25 Psi, although other pressures and types of check valves are considered. The flow control member 32 generally prevents liquids and dirt from entering the shaft tube 11. In an optional embodiment, the flow control member 32 is a plug that is screwed off when purging operation takes place.

Although a single purge channel 31 is illustrated in FIGS. 2 and 3, it is considered to provide numerous purge channels to facilitate the purge of lubricant out of the reserve 20 (i.e. at the actuating end of the tube 11), or other configurations of purge outlets.

Accordingly, in order to change the lubricant in the lubricant reserve 20, a lubricant supply is fed to the reserve 20 using the injection port 22A. The lubricant pressure will increase in the reserve 20, resulting in lubricant exiting the reserve 20 through the actuated end as the seal 24 will deform to allow lubricant out of the reserve 20 to change the lubricant between the channel 22 and the seal 24.

The pressure increase will maintain the seal 23 in a loaded condition at the application end, resulting in the lubricant exerting increased pressure on the flow control member 32 at the exit end of the channel 31. As the pressure level reaches the trigger limit of the flow control member 32, the flow control member 32 will open to allow lubricant to exit therethrough. A continuous supply of lubricant will lead to a change in lubricant between the channel 22 and the flow control member 32 such that both bearing journals are lubricated positively with renewed lubricant.

It is seen in FIGS. 2 and 3 that the lubricant reserve has different diameters in the shaft tube 11. This is a configuration that is used to lessen the amount of material used in the shaft tube 11.

The shaft tube described above is typically used in air-brake systems of vans, but may be used with any type of vehicle or trailer that uses shaft tubes. Moreover, the shaft tube in accordance with the described embodiments can be in different sizes to accommodate different dimensions of cam shafts.

The possibility of using the actuated end seal 24 to be installed with its cup facing toward the lubricant reserve 20 to lock in the reserve would require having a similar purge system at the actuating end of the tube to again ensure proper lubricant renewal at this end of the tube when lubricating the assembly. Such configuration is particularly practical in some industrial ox other application designs in which it is necessary to prevent contamination of a product or process (e.g., food processing or pharmaceutical industry) For instance, it may be required to provide an additional seal between the tube 11 and the spider bracket 14′ to prevent contamination. Accordingly, the use of a positively arranged cup seals at both ends of the tube 11 and on the outside of the tube 11 holds the lubricant in the tube 11 during use. When there are a plurality of the outlets for the purge system 30, it is considered to interconnect all purge outlets, for instance by way of piping or tubing.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure, and such modifications are intended to fall within the equivalents accorded to the appended claims.

1. A shaft-tube system comprising:
a shaft having an elongated body, a cam at a brake end and a coupler at an actuated end;
a shaft tube accommodating the shaft such that a cavity is defined between the elongated body of the shaft and an interior of the shaft tube with the shaft being rotatable along its longitudinal axis within the shaft tube, the shaft tube having a blockable inlet in fluid communication with the cavity to supply lubricant to the cavity;
seals positioned between the shaft and the shaft tube at opposed ends of the shaft tube so as to define a lubricant reserve in said cavity, to lubricate the shaft with respect to the interior of the shaft tube; and
a purge system having at least one purge outlet in the shaft tube in fluid communication with the cavity adjacent to the brake end for lubricant from the lubricant reserve to be purged therethrough, and a flow control member for each said purge outlet restricting an exit of lubricant through the purge outlet,

2. The shaft tube system according to claim 1, wherein the purge outlet is one purge channel extending along the shaft tube.

3. The shaft tube system according to claim 1, wherein the flow control member is a check valve openable at a selected pressure threshold.

4. The shaft tube system according to claim 1, wherein the flow control member is a plug threadingly engaged to the purge outlet.

5. The shaft tube system according to claim 1, wherein the seal at the actuated end is a cup seal oriented toward the lubricant reserve so as to be loaded by a lubricant pressure in the lubricant reserve, and further comprising another one of the purge system having at least one purge outlet in the shaft tube in fluid communication with the cavity adjacent to the actuated end for lubricant from the lubricant reserve to be purged therethrough, and a flow control member for each said purge outlet restricting an exit of lubricant through the purge outlet.

6. The shaft tube system according to claim 1, wherein the purge system has at least two purge outlets in the shaft tube in fluid communication with the cavity adjacent to the brake end for lubricant from the lubricant reserve to be purged therethrough, and a flow control member for each said purge outlet restricting an exit of lubricant through the purge outlet.

7. The shaft tube system according to claim 1, wherein the cam of the shaft is an S-cam.

8. The shaft tube system according to claim 1, wherein the coupler of the shaft is a spline.

9. The shaft tube system according to claim 1, wherein the seal at the actuated end is a cup seal oriented away from the lubricant reserve so as to allow a purge of the lubricant reserve by deforming when the lubricant in the lubricant reserve is above selected pressure threshold.
